(19) United States
(12) Patent Application Publication
(10) Pub. No.: US 2014/0271387 A1
(43) Pub. Date: Sep. 18, 2014

(54) Optimal Composition of Copper-Manganese Spinel in ZPGM Catalyst for TWC Applications

(71) Applicant: Zahra Nazarpoor, Camarillo, CA (US)

(72) Inventor: Zahra Nazarpoor, Camarillo, CA (US)

(73) Assignee: CDTi, Ventura, CA (US)

(21) Appl. No.: 14/097,871

(22) Filed: Dec. 5, 2013

Related U.S. Application Data
(63) Continuation-in-part of application No. 13/849,169, filed on Mar. 22, 2013.
Application No. 13/849,169 is a continuation-in-part of application No. 13/849,230, filed on Mar. 22, 2013.
(60) Provisional application No. 61/791,721, filed on Mar. 15, 2013.
(60) Provisional application No. 61/791,838, filed on Mar. 15, 2013.

(51) Int. Cl. B01J 23/889

(52) U.S. Cl. CPC B01J 23/8892
USPC 422/170; 502/324

(57) ABSTRACT

It is an object of the present disclosure, to provide an optimized catalyst composition with variations of Cu and Mn molar ratio, which may include a formulation CuₓMn₃₋ₓO₄ spinel, with a plurality of molar ratio variations for selecting the optimal Cu—Mn molar ratio for TWC application. The formulation may include a support oxide, such as Nb₂O₅—ZrO₂. Employing this optimized Cu and Mn ratio in spinel as overcoat may achieve optimal NO conversion, high catalyst activity, and enhanced thermal stability, having a chemical composition substantially free from PGM and rare earth metals. According to principles of the present disclosure, the disclosed Cu—Mn spinel on Nb—Zr support oxide for TWC applications may require a washcoat of alumina, and overcoat of Cu—Mn spinel on Nb—Zr support oxide.

### CROSS-REFERENCE TO RELATED APPLICATIONS

This application is a continuation-in-part of U.S. patent application Ser. Nos. 13/849,169 and 13/849,230, filed Mar. 22, 2013, respectively, and claims priority to U.S. Provisional Application Nos. 61/791,721 and 61/791,838, filed Mar. 15, 2013, respectively, and is related to U.S. patent application Ser. No. 14/090,861, filed Nov. 26, 2013, entitled System and Methods for Using Synergized PGM as a Three-Way Catalyst.

### BACKGROUND

1. Field of the Disclosure

This disclosure relates generally to non-PGM catalyst materials, and more particularly to an optimal composition of Cu—Mn in spinel catalyst for TWC applications.

2. Background Information

The use of automobile exhaust gas catalysts has contributed to a significant improvement in air quality. In typical after-treatment architecture, the engine exhaust is sent through a three way converter (TWC). Common three way converters may work by converting carbon monoxide, hydrocarbons, and nitrogen oxides into less harmful compounds or pollutants.

Internal combustion engines produce exhaust gases having compositions that oscillate over time between air/fuel ratios that are slightly rich of stoichiometric, and ratios that are slightly lean of stoichiometric. However, a common problem among conventional active phase catalysts may be related to NO and CO conversion efficiency, which may fall very rapidly when the engine is operated outside of that band of air/fuel stoichiometric ratio. Under lean engine operations, there is excess oxygen and the reduction of NOx is not favored. Under rich conditions, the excess of fuel consumes all of the available oxygen prior to the catalyst.

Recent environmental concerns for a catalyst's high performance have increased the focus on the operation of a TWC catalyst at the end of its lifetime. Catalytic materials used in TWC applications have also changed, and the new materials requires being thermally stable under the fluctuating exhaust gas conditions.

Current commercial three way catalysts preferably use platinum group metal (PGM) to overcome this issue, which in turn drives up their cost and therefore the cost of catalysts applications. Accelerated catalyst reaction and enhanced performance is desirable, which is particularly important for meeting increasingly stringent state and federal government vehicle emissions standards.

Therefore, there is a continuing need for cost effective catalyst systems that is free of PGM, capable to provide sufficient conversion so that NOx, CO and HC to satisfy existing emission standards for TWC application system, which may also have high OSC properties, thermal stability, high activity, and enhanced conversion capabilities.

### SUMMARY

It is an object of the present disclosure, to provide an optimal composition of Cu—Mn spinel for TWC applications. The formulation may include a support oxide, such as Nb₂O₅—ZrO₂ for achieving optimal catalyst activity, and enhanced thermal stability, having a chemical composition substantially free from PGM and rare earth metals.

According to principles of the present disclosure, the disclosed Cu—Mn spinel on Nb—Zr support oxide for TWC applications, may require a washcoat of pure alumina, and overcoat of Cu—Mn spinel on Nb—Zr support oxide with a total loading of 120 g/L.

According to one embodiment, for Cu—Mn spinel phase with Niobium-Zirconia support oxide, the material may be dried and calcined at about 600° C. to form spinel structure.

According to embodiments in the present disclosure, the disclosed Cu—Mn spinel with varied spinel composition on Nb—Zr support oxide substantially free from PGM, may be prepared using suitable known in the art synthesis method. In order to prepare washcoat, co-milling process may be employed. Additionally, in order to prepare overcoat a co-precipitation method may be employed. The preparation process may include a washcoat of pure alumina and an overcoat of Cu—Mn spinel on Nb—Zr support oxide, which may include samples preparation with variations of Cu—Mn molar ratio for experimentation.

According to one aspect of the present disclosure, fresh and aged samples of disclosed Cu—Mn spinel on Nb—Zr support oxide may be prepared in order to determine the effect of the temperature and gas flow conditions to determine the activity and thermal stability by performing rich to lean sweep tests under steady state, oscillating condition, and steady state light-off tests and compare results of a plurality of spinel compositions to determine optimal performance.

In another embodiments, a steady state sweep test and oscillating sweep test may be performed to compare NO/CO crossover R-values for fresh and aged samples prepared employing composition variations of “x” in CuₓMn₃₋ₓO₄ formulation, demonstrating dependency on Cu—Mn ratio.

A steady state light off test may be performed on fresh and hydrothermally aged samples to compare the catalytic activities of NO T50, CO T50, and HC T50 values, using a plurality of spinel compositions, “x” in CuₓMn₃₋ₓO₄, with Nb—Zr support oxide, according to principles of the present disclosure.

The present disclosure may provide solutions to optimize ZPGM catalyst for TWC applications, employing variations of Cu—Mn spinel compositions with Nb—Zr support oxide applied in overcoat for achieving optimized thermal stability and enhanced performance of NO, CO and HC conversion.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows ZPGM system configuration of Cu—Mn spinel with Nb—Zr support oxide as overcoat, according to an embodiment.

FIG. 2 shows steady state sweep test of fresh samples CuₓMn₃₋ₓO₄ where x=0.75, according to an embodiment.

FIG. 3 shows steady state sweep test of fresh samples for improvements of NO conversion response in samples with variations of x in CuₓMn₃₋ₓO₄, according to an embodiment.

FIG. 4 depicts steady state sweep test for aged samples CuₓMn₃₋ₓO₄ where x=0.5 and 0.75, according to an embodiment.

FIG. 5 shows a summary of steady state sweep test and oscillating sweep test variations of x in CuₓMn₃₋ₓO₄, according to an embodiment.

FIG. 6 shows NO T50 values for variations of x in CuₓMn₃₋ₓO₄, according to an embodiment

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group Metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat layer.

“Milling” refers to the operation of breaking a solid material into a desired grain or particle size.

“Co-precipitation” may refer to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Air/Fuel ratio” or “A/F ratio” refers to the weight of air divided by the weight of fuel.

“Three-Way Catalyst” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“T50” may refer to the temperature at which 50% of a material is converted.

### DESCRIPTION OF THE DRAWINGS

It is an object of the present disclosure, to provide an optimized catalyst material composition with variations of Cu and Mn ratio in spinel structure, which may include a formulation CuₓMn₃₋ₓO₄ with variations of x=0.5, x=0.75 and x=1.0 for selecting the optimal Cu—Mn molar ratio, additionally may include a support oxide, such as Nb₂O₅—ZrO₂. Employing this formulation as overcoat may achieve optimal OSC properties, high catalyst activity, and enhanced thermal stability for TWC application.

ZPGM System Configuration of Cu—Mn Spinel with Nb—Zr Support Oxide as Overcoat

FIG. 1 describe the Cu—Mn spinel with Nb—Zr support oxide configuration for TWC applications, having a chemical composition substantially free from PGM, according to principles of the present disclosure

As shown in FIG. 1, ZPGM catalyst system 100 may include at least a substrate 102, a washcoat 104, and an overcoat 106, where washcoat 104 may include carrier material oxides, such as alumina and overcoat 106 may include a Cu—Mn spinel with Nb₂O₅—ZrO₂ as support oxide.

In an embodiment, substrate 102 materials may include a refractive material, a ceramic material, a honeycomb structure, a metallic material, a ceramic foam, a metallic foam, a reticulated foam, or suitable combinations, where substrate 102 may have a plurality of channels with suitable porosity. Porosity may vary according to the particular properties of substrate 102 materials. Additionally, the number of channels may vary depending upon substrate 102 used as is known in the art. The type and shape of a suitable substrate 102 would be apparent to one of ordinary skill in the art.

According to the present disclosure, preferred substrate material may be ceramic material.

Washcoat 104 may include aluminum oxide, doped aluminum oxide, spinel, delafossite, lyonsite, garnet, perovskite, pyrochlore, doped ceria, fluorite, zirconium oxide, doped zirconia, titanium oxide, tin oxide, silicon dioxide, zeolite, and mixtures thereof.

According to the present disclosure, most suitable material for disclosed washcoat 104 may be alumina (Al₂O₃).

According to an embodiment, overcoat 106 may include a Cu—Mn spinel, CuₓMn₃₋ₓO₄, as ZPGM transition metal catalyst. Additionally, overcoat 106 may include support oxide, such as Nb₂O₅—ZrO₂.

Composition and Preparation of Washcoat and Overcoat Material

A ZPGM catalyst system 100 including a ceramic substrate 102, a washcoat 104, and an overcoat 106 may be prepared, as follows:

In order to prepare washcoat 104, co-milling process may be employed. Co-milling process may begin with mixing alumina with water or any suitable organic solvent. Suitable organic solvents may include ethanol, diethyl ether, carbon tetrachloride, trichloroethylene, among others. Milling process in which washcoat 104 materials may be broken down into smaller particle sizes, may take about 10 minutes to about 10 hours, depending on the batch size, kind of material and particle size desired. The milled alumina may be deposited on substrate 102 in the form of washcoat 104, and then thermally treated. Washcoat 104 may be thermally treated or fired for about 4 hours at a temperature of about of 550° C. to about 700° C., preferably 550° C. Various capacities of washcoat 104 loadings may be coated on the ceramic substrate 102. Washcoat 104 loading may vary from 60 g/L to 200 g/L, most suitable washcoat 104 loading may be 120 g/L.

The preparation of overcoat 106 may begin by milling Nb₂O₅—ZrO₂ support oxide to make aqueous slurry. The Nb₂O₅—ZrO₂ support oxide may have Nb₂O₅ loadings of about 15% by weight to about 30% by weight, preferably about 25% and ZrO₂ loadings of about 70% by weight to about 85% by weight, preferably about 75% by weight.

The Cu—Mn solution may be prepared by mixing an appropriate amount of Mn nitrate solution (MnNO₃) and Cu nitrate solution (CuNO₃), for a desired Cu and Mn ratio in CuₓMn₃₋ₓO₄ where the suitable copper loadings may include loadings in a range of about 10% to about 15% by weight. Suitable manganese loadings may include loadings in a range of about 15% to about 25% by weight. The next step is precipitation of Cu—Mn nitrate solution on Nb₂O₅—ZrO₂ support oxide aqueous slurry, which may have added thereto an appropriate base solution, such as in order to adjust the pH of the slurry to a suitable range. The precipitated slurry may be aged for a period of time of about 12 to 24 hours under continued stirring at room temperature.

For preparation of overcoat 106, after precipitation step, the Cu—Mn/Nb₂O₅—ZrO₂ slurry may be coated on washcoat 104 in order to form overcoat 106 employing suitable coating techniques as known in the art, such as vacuum dosing, among others. Overcoat 106 loading may vary from about 60 g/L to about 200 g/L, in this disclosure particularly about 120 g/L.

According to embodiments in the present disclosure, treatment of overcoat 106 may be achieved employing suitable drying and heating processes. A commercially-available air knife drying system may be employed for drying overcoat 106. Heat treatments may be performed using commercially available firing (calcination) systems. The thermal treatment may take from about 2 hours to about 6 hours, preferably about 5 hours, at a temperature within a range of about 550° C. to about 650° C., preferably at about 600° C.

### Example #1

### Cu_{0.5} Mn_{2.5}O₄ Spinel with ZrO₂—Nb₂O₅Support Oxide

Preparation of EXAMPLE #1 as ZPGM catalyst system 100 may include samples of CuₓMn₃₋ₓO₄ spinel as described above where x=0.5, Cu_{0.5} Mn_{2.5} O₄ composition with ZrO₂—Nb₂O₅ support oxide, having a Cu loading 6.6 g/L, and Mn loading of 28.2 g/L. The total loading of OC is 120 g/L.

### Example #2

### Cu_{0.75} Mn_{2.25} O₄Spinel with ZrO₂—Nb₂O₅ Support Oxide

Preparation of EXAMPLE #2 as ZPGM catalyst system 100 may include samples of CuₓMn₃₋ₓO₄ spinel as described above where x=0.75, Cu_{0.75} Mn_{2.25} O₄ composition with ZrO₂—Nb₂O₅ support oxide, having a Cu loading of 9.8 g/L, and Mn loading of 25.4 g/L. The total loading of OC is 120 g/L.

### Example #3

### Cu_{1.0} Mn_{2.0} O₄ Spinel with ZrO₂—Nb₂O₅ Support Oxide

Preparation of EXAMPLE #3 as ZPGM catalyst system 100 may include samples of CuₓMn₃₋ₓO₄ spinel as described above where x=1.0, Cu_{1.0} Mn_{2.0} O₄ composition with ZrO₂—Nb₂O₅ support oxide, having a Cu loading of 13.0 g/L, Mn loading of 22.4 g/L. The total loading of OC is 120 g/L.

Isothermal Steady State Sweep Test Procedure

The isothermal steady state sweep test may be carried out employing a flow reactor at inlet temperature of about 450° C., and testing a gas stream at 11-point R-values from about 2.0 (rich condition) to about 0.80 (lean condition) to measure the CO, NO, and HC conversions at inlet temperature of 450° C.

The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NOₓ, about 2,000 ppm of H₂, 10% of CO₂, and 10% of H₂O. The quantity of O₂ in the gas mix may be varied to adjust Air/Fuel (A/F) ratio.

The following examples are intended to illustrate the scope of the disclosure. It is to be understood that other procedures known to those skilled in the art may alternatively be used.

Oscillating Sweep Test Procedure

According to an embodiment, the oscillating sweep test was performed employing a test reactor at an inlet temperature of 450° C. The test covered 11 R-value points from rich condition (R=2.0) to lean condition (R=0.80). Oscillating sweep test was conducted, under a frequency of 1 Hz with 0.4 AFR spans, over fresh and aged samples, with simulated exhaust gas, at a space velocity (SV) of 40,000 Hr-1, to stimulate a portion of full life aging of an under-floor catalyst.

The simulated exhaust gas for standard TWC gas composition, which may include 8,000 ppm of CO, 400 ppm of C₃H₆, 100 ppm of C₃H₈, 1000 ppm of NOₓ, 2000 ppm of H₂, 10% of CO₂, 10% of H₂O. A quantity of O₂ may be oscillated to represent the three-way condition of the control loop in an exhaust system, where the air-fuel ratio (A/F) oscillates between rich and lean conditions.

Standard Steady State Light-Off Test Procedures

TWC steady state light-off test may be carried out employing a flow reactor in which temperature may be increased from about 100° C. to about 500° C. at a rate of about 40° C./min, feeding a gas composition of 8,000 ppm of CO, 400 ppm of C₃H₆, 100 ppm of C₃H₈, 1,000 ppm of NOₓ, 2,000 ppm of H₂, 10% of CO₂, 10% of H₂O, and 0.7% of O₂. The average R-value is 1.2, at SV of about 40,000 h⁻¹.

TWC standard oscillating light-off test may be carried out employing a flow reactor in which temperature may be increased from about 100° C. to about 500° C. at a rate of about 40° C./min, feeding a gas composition of 8,000 ppm of CO, 400 ppm of C₃H₆, 100 ppm of C₃H₈, 1,000 ppm of NOₓ, 2,000 ppm of H₂, 10% of CO₂, 10% of H₂O, and O₂ quantity is approximately 0.7%.

Isothermal Steady State and Oscillating Sweep Tests on Fresh and Aged Samples of CuₓMn₃₋ₓO₄ with Variation of x

The graph of FIG. 2 shows steady state sweep test 200 employing ZPGM catalyst system of Example#2 where Cu_{0.75}Mn_{2.25}O₄. As may be seen in FIG. 2, the test results of percent conversion of fresh samples have been identified as NO curve 202, CO curve 204, and HC curve 206. In fresh samples, the NO/CO cross over takes place at the specific R-value of 1.193 where the NO and CO conversion is substantially about 99.7%. Additionally, test results obtained under isothermal steady state sweep condition shows an enhanced NO and CO conversion employing ratio x=0.75, which is about 90% NO conversion, 100% of CO conversion and 58% of HC conversion at R-value 1.

The graph of FIG. 3 shows NO conversion comparison 300 under steady state isothermal sweep test employing ZPGM catalyst system of variation of Cu—Mn spinel compositions for determination of optimal Cu—Mn ratio.

Fresh samples prepared per EXAMPLE #1 may include a formulation of CuₓMn₃₋ₓO₄ where x=0.5 with ZrO₂—Nb₂O₅ support oxide. Fresh samples prepared per EXAMPLE #2 may include a formulation of CuₓMn₃₋ₓO₄ where x=0.75 with ZrO₂—Nb₂O₅ support oxide. Fresh samples prepared per EXAMPLE #3 may include a formulation of CuₓMn₃₋ₓO₄ where x=1.0 with ZrO₂—Nb₂O₅ support oxide.

As may be seen in FIG. 3 depicts NO conversion comparison 300, have been identified as x=1.0 curve 302 corresponds to ZPGM sample of Example#1, x=0.75 curve 304 corresponds to ZPGM sample of Example#2, and x=0.5 curve 306 corresponds to ZPGM sample of Example#3.

The results shows improvement of NO conversion toward lean regions (R-value<1.0) by increasing the amount of Cu in CuₓMn₃₋ₓO₄. For example, at R-value=1.1, Cu_{0.5}Mn_{2.5}O₄ of Example#1 shows NO conversion of 78.0%, while Cu_{0.55}Mn_{2.25}O₄ of Example#2 shows NO conversion of 90.0% and Cu1.0Mn_{2.0}O₄ of Example#3 shows NO conversion of 100.0%

Test results shows improvements of NO conversion performance by increasing the molar ratio from about x=0.5 to about x=1.0 in CuₓMn₃₋ₓO₄. This improved performance of NO conversion is the result of optimized composition of Cu—Mn spinel for TWC applications.

The graph of FIG. 4 shows performance comparison 400 of NO and CO conversion under steady state isothermal sweep test at 450° C. for aged ZPGM catalyst systems of Example #1 and Example#2. Aging for both samples may be done at about 800° C. for about 20 hours under fuel condition. Samples may be prepared per EXAMPLE #1 with CuₓMn₃₋ₓO₄ where x=0.5 in with ZrO₂—Nb₂O₅ support oxide, for comparison of best performance with aged samples prepared per EXAMPLE #2 with CuₓMn₃₋ₓO₄ where x=0.75 with ZrO₂—Nb₂O₅ support oxide.

As may be seen in FIG. 4, the test results of percent conversion of aged samples with molar ratio x=0.5 has been identified as x=0.5 curve 402 for NO and x=0.5 curve 404 for CO, and which may be used for comparison with x=0.75 molar ratio identified as x=0.75 curve 406 for NO and x=0.75 curve 408 for CO, for determination of best performance of NO and CO conversion.

On aged samples for x=0.5 the NO/CO cross over takes place at the specific R-value of 1.38, where the NO and CO conversion is 90%. On aged samples for x=0.75 the NO/CO cross over takes place at the specific R-value of 1.27, where the NO and CO conversion is 96%. Comparison of sweep data after aging, shows higher Cu mole ratio helps improvement of NO conversion toward lean burn. In addition, the results shows ZPGM catalyst of Cu—Mn spinel is very stable after aging; however, Cu_{0.75}Mn_{2.25}O₄ shows better stability than Cu_{0.5}Mn_{2.5}O₄.

After comparison of test results shows samples with x=0.75 molar ratio exhibit improved performance of NO/CO cross over conversion compared with aged samples with x=0.5 molar ratio, even after aging samples of Cu—Mn spinel on Niobium Zirconia support oxide for an extended period of time of about 20 hours at 800° C. and under fuel condition.

FIG. 5 shows a summary of steady state sweep test and oscillating sweep test with variations of molar ratio x in CuₓMn₃₋ₓO₄ for performance comparison 500 of NO/CO cross over R-values for fresh samples of ZPGM catalyst systems of Example #1, Example#2, and Example#3.

As may be seen in FIG. 5, results of steady state sweep tests (vertical lines bars) for CuxMn3-xO4 where x=0.5 bar chart 502, the NO/CO cross over may observed at R-value 1.255. This result may be similar to oscillating sweep test (square mesh patterns) CuxMn3-xO4 where fresh x=0.5 bar chart 504 with NO/CO cross over R-value 1.26.

Results of steady state sweep tests (vertical lines bars) for CuxMn3-xO4 where x=0.75 bar chart 506, the NO/CO cross over may observed at R-value 1.193. This result may be similar to oscillating sweep test (square mesh patterns) CuxMn3-xO4 where x=0.5 bar chart 508 with NO/CO cross over R-value 1.19.

Results of steady state sweep tests (vertical lines bars) for CuxMn3-xO4 where x=1.0 bar chart 510, the NO/CO cross over may observed at R-value 1.158. This result may be similar to oscillating sweep test (square mesh patterns) CuxMn3-xO4 where x=1.0 bar chart 512 with NO/CO cross over R-value 1.16.

As may be observed in performance comparison 500, the NO/CO cross over R-value decreased by increasing the Cu molar ratio from X=0.5 to X=1.0 under steady state and oscillating sweep tests. Test results shows improvement in NOX conversion with optimal Cu—Mn spinel composition in Cu_{1.0}Mn_{2.0}O₄. This result shows stoichiometric composition of Cu—Mn spinel, Cu_{1.0}Mn_{2.0}O₄, may be optimal composition of spinel in order to achieve optimal NO performance. In addition, disclosed ZPGM catalyst system shows similar performance under steady state and oscillating condition. The Cu—Mn spinel ZPGM system is stable under oscillating condition that is great factor for TWC application.

Steady State Light-Off Test on Fresh and Aged Samples of CuₓMn₃₋ₓO₄ with Variation of x

FIG. 6 shows test results of steady light off test with variations of molar ratio “x” in CuₓMn₃₋ₓO₄ on Nb2O5-ZrO2 support oxide, for NO conversion comparison 600, as described as NO T50 values of fresh and hydrothermally aged samples. Samples are hydrothermally aged at 900° C. for 4 hours under 10% steam flow.

As may be seen in FIG. 6, the first two bars on left side of chart (dotted mesh pattern) represent test results for NO T50 values of ZPGM catalyst system of Example#3 with x=1.0 for fresh and aged samples for comparison of NO T50 values. Fresh samples are identified with Fresh x=1.0 bar chart 602 shows NO T50 value of 446° C., for aged samples at 900° C. identified with aged x=1.0 bar chart 604 shows NO T50 value of 434° C.

For CuₓMn₃₋ₓO₄ where x=1.0, aged sample exhibit improvement of NO conversion compared to fresh sample, as shown by decreasing NO T50 values. This is positive effect, showing thermal stability of stoichiometric composition of Cu—Mn spinel, Cu_{1.0}Mn_{2.0}O₄.

The second set of two bars on the middle of chart (slanted bars pattern) represent test results for NO T50 values of ZPGM catalyst system of Example #2, with x=0.75 for fresh and aged samples, for comparison of NO T50 values. Fresh samples are identified with fresh x=0.75 bar chart 606 shows NO T50 value of 431° C., for aged samples at 900° C. identified with aged x=0.75 bar chart 608 shows NO T50 value of 445° C.

For CuₓMn₃₋ₓO₄ where x=0.75, aged sample shows decrease in NO performance, as shown by increasing the NO T50 value.

The third set of two bars on the right hand side of chart (vertical bars pattern) represent test results for NO T50 values of ZPGM catalyst system of Example#1 with x=0.5 for fresh and aged samples for comparison of NO T50 values, as follows: Fresh samples identified with fresh x=0.5 bar chart 610 shows NO T50 value of 437° C., for aged samples at 900° C. identified with aged x=0.5 bar chart 612 shows NO T50 value of 441° C.

For CuₓMn₃₋ₓO₄ where x=0.5, aged sample shows slightly decrease in NO performance, as shown by increasing the NO T50 value.

Comparison of light off test results shows that fresh samples exhibit a higher NO conversion for Cu—Mn spinel with molar ratio x=0.5, as shown by the lowest NO T50 value. For hydrothermal aged samples at 900° C. exhibit a higher NO conversion for Cu—Mn spinel with molar ratio x=1.0 as shown by lowest NO T50 value. These data shows a higher stability of stoichiometric composition of Cu—Mn spinel, Cu_{1.0}Mn_{2.0}O₄.

After analysis of sweep tests data and light off test results from both, fresh and aged disclosed ZPGM samples, has been determined the optimal Cu—Mn spinel composition for TWC applications, which may provide optimal thermal stability at different temperatures when compared with PGM catalysts, as well as presenting an enhanced behavior and thermal stability under steady state and oscillating exhaust condition. The optimized ratio for stoichiometric Cu—Mn spinel, Cu_{1.0}Mn_{2.0}O₄ may be employed as optimal Cu—Mn spinel composition for close-coupled and underfloor catalytic converters for a plurality of ZPGM catalysts for TWC applications.

While various aspects, and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst system, comprising:
at least one substrate;
at least one first coating applied to the at least one substrate comprising at least one oxygen storage material; and
wherein the at least one oxygen storage material comprises Cu—Mn spinel having a niobium-zirconia support oxide; and
wherein the Cu—Mn spinel has a general formula of CuₓMn₃₋ₓO₄, wherein the Cu molar ratio is from about x=0.5 to about x=1.0.

2. The catalyst system of claim 1, further comprising at least one second coating comprising Al₂O₃.

3. The catalyst system of claim 1, wherein the at least one first coating is substantially free of platinum group metals.

4. The catalyst system of claim 1, wherein the at least one first coating is substantially free of rare earth metals.

5. The catalyst system of claim 1, wherein the at least one first coating is a washcoat.

6. The catalyst system of claim 1, wherein the conversion of NO increases as x increases.

7. The catalyst system of claim 1, wherein x is 0.75.

8. The catalyst system of claim 1, wherein the T50 of NO is less than 435° C.

9. The catalyst system of claim 1, wherein the T50 of NO is 445° C.

10. The catalyst system of claim 1, wherein rein the at least one oxygen storage material is aged at about 900° C.

11. The catalyst system of claim 1, wherein the at least one oxygen storage material is aged at about 1000° C.

12. The catalyst system of claim 1, wherein CO conversion that occurs under isothermal oscillating conditions.

13. A catalyst system for use during an urban drive cycle, the catalyst system comprising:
at least one close-couple converter; and
at least one underfloor converter;
wherein the underfloor converter comprises a catalyst system, comprising:
a substrate; and
a washcoat suitable for deposition on the substrate, comprising at least one oxygen storage material and alumina;
wherein the at least one oxygen storage material comprises Cu—Mn spinel having a niobium-zirconia support oxide; and
wherein the Cu—Mn spinel has a general formula of CuₓMn₃₋ₓO₄, wherein the Cu molar ratio is from about x=0.5 to about x=1.0.

14. The catalyst system of claim 13, wherein the washcoat is substantially free of platinum group metals.

15. The catalyst system of claim 13, wherein the washcoat is substantially free of rare earth metals.

16. The catalyst system of claim 13, wherein the conversion of NO increases as x increases.

17. The catalyst system of claim 13, wherein x is 0.75.

18. The catalyst system of claim 13, wherein the T50 of NO is less than 435° C.

19. The catalyst system of claim 13, wherein the T50 of NO is 445° C.

20. The catalyst system of claim 13, wherein rein the at least one oxygen storage material is aged at about 900° C.

21. The catalyst system of claim 13, wherein the at least one oxygen storage material is aged at about 1000° C.

22. The catalyst system of claim 13, wherein CO conversion that occurs under isothermal oscillating conditions.
